(19) United States
(12) Patent Application Publication
(10) Pub. No.: US 2018/0178982 A1
(43) Pub. Date: Jun. 28, 2018

(54) A METHOD OF TAKING ARTICLES BY USING SHUTTLE ROBOT CARTS

(71) Applicant: Solystic, Bagneux (FR)

(72) Inventors: Luc CHIROL, Paris (FR); Emmanuel MIETTE, Saint-Gratien (FR)

(21) Appl. No.: 15/502,093

(22) PCT Filed: Aug. 9, 2016
(86) PCT No.: PCT/FR2016/052057

§ 371 Date: Feb. 6, 2017

(30) Foreign Application Priority Data
Sep. 15, 2015 (FR) 1558618

(51) Int. Cl. B65G 1/137; B25J 9/16

(52) U.S. Cl. CPC B65G 1/1375; B25J 9/162; Y10S 901/01; B65G 2201/0285; B25J 9/1664

(57) ABSTRACT

A method of handling articles (3) in a logistics center including an article stowage zone (1) subdivided into adjacent stowage segments along a travel path (2) for shuttle robot carts (4), in which method a monitoring and control unit (5) organizes the movement of said shuttle robot carts along the travel path in such a manner as to take the articles from the segments and to cause them to exit from the travel path in series and in ordered manner in a certain sequence, which method is characterized in that the unit causes the shuttle robot carts to move cyclically, and, at each cycle, checks the distribution of the articles in the segments in such a manner that, every time, an optimum number of shuttle robot carts are caused to move along the travel path.

### TECHNICAL FIELD

The invention relates to handling articles in a logistics center, and in particular handling parcels in a parcel sorting logistics center having a parcel stowage zone where the parcels arriving at the center are stowed pending being taken again and loaded onto a truck in a certain sequence, e.g. for them to be delivered by a postperson or a delivery person.

Such a method is already known from Patent FR 2 996 788.

In that known method, the parcels are moved around the logistics center by means of shuttle robot carts that are mobile movement units. In that known method, the parcels are placed on nesting-type racks, one parcel per rack, which racks are moved by shuttle robot carts that are designed for that purpose.

The nesting racks are of the type constituted by trolleys of different heights and widths so that they can nest together.

The stowage zone is subdivided into adjacent stowage segments along a travel path along which the shuttle robot carts travel. A monitoring and control unit organizes the movement of the shuttle robot carts along the travel path in such a manner as to take the articles from the segments and to cause them to exit from the travel path in series and in ordered manner in a certain sequence.

In general, for reducing the footprint on the floor, the travel path is a two-way single-track path that the shuttle robot carts can access from one end only. In each segment, it is possible to have a superposition of parcels on nesting racks. It is possible to have stowage segments on both sides of a travel path for shuttle robot carts. It is possible to have a plurality of rows of adjacent segments and to have a plurality of travel paths along said rows of segments.

An object of the invention is to optimize the movement of the shuttle robot carts along a travel path in such a manner as to speed up as much as possible the loading of the parcels onto the truck in the sequential order.

To this end, the invention provides a method of handling articles in a logistics center including an article stowage zone subdivided into adjacent stowage segments along a travel path for shuttle robot carts, in which method a monitoring and control unit organizes the movement of said shuttle robot carts along the travel path in such a manner as to take the articles from the segments and to cause them to exit from the travel path in series and in ordered manner in a certain sequence, said method being characterized in that the monitoring and control unit causes the shuttle robot carts to move cyclically along the travel path, and, in that, on the basis of a distribution plan indicating the distribution of the articles in the segments of the stowage zone, and on the basis of said ordered sequence, at each cycle, the monitoring and control unit checks whether or not a plurality of articles to be taken are stowed along the travel path in the sequential order, and, if so, causes to move along the travel path as many shuttle robot carts as there are articles to be taken in the sequential order, and, otherwise, causes a single shuttle robot cart to move along the travel path for the purpose of taking a single article.

In a feature of the method of the invention, the monitoring and control unit causes shuttle robot carts to move around a travel loop that is connected to a plurality of travel paths.

The basic idea of the invention is to provide cyclic control for controlling the shuttle robot carts, and, at each cycle, to observe the distribution of the articles that can be taken in sequence so as to optimize the number of shuttle robot carts that can be moved simultaneously and in series with articles along the travel path, while complying with the sequential order for those articles.

### BRIEF DESCRIPTION OF THE DRAWINGS

FIG. 1 is a highly diagrammatic view showing a distribution indicating how parcels are distributed in segments of a stowage zone of a logistics center that are adjacent to one another along a travel path for shuttle robot carts;

FIG. 2 shows an ordered sequence of the articles;

FIG. 3 shows a plurality of cycles of movements of shuttle robot carts for taking the parcels in the sequential order from the segments of the stowage zone;

FIG. 4 is a highly simplified flow chart showing the process of controlling the shuttle cart robots; and

FIG. 5 is a diagrammatic view of a stowage zone with a plurality of travel paths for robot shuttle carts, which paths are connected to a travel loop.

### DESCRIPTION OF IMPLEMENTATIONS

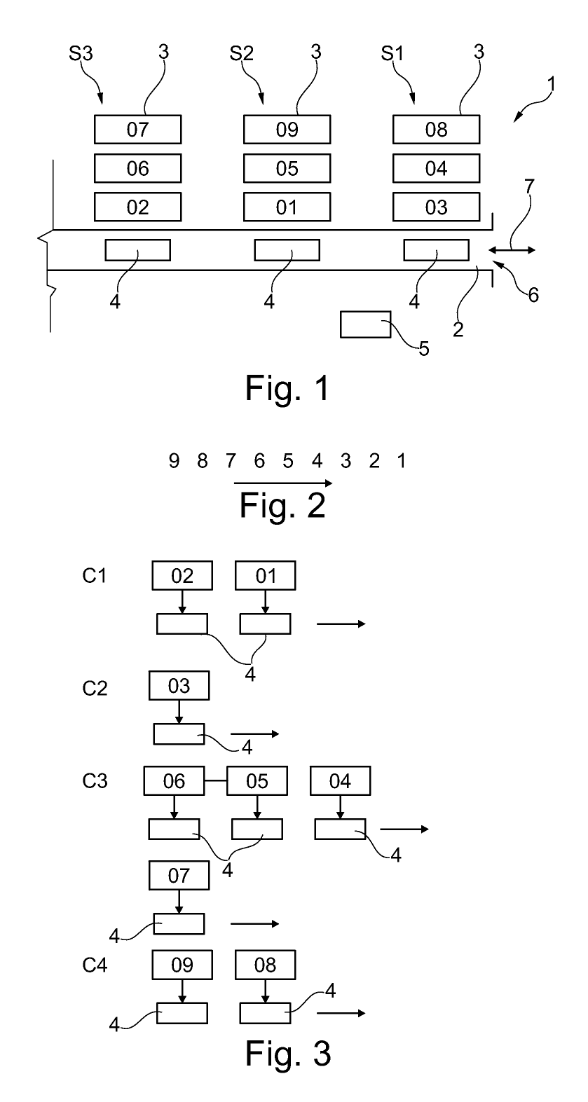

FIG. 1 is a highly diagrammatic view showing three segments S1, S2, and S3 of a stowage zone 1 in a logistics center, which segments are adjacent along a travel path 2.

In FIG. 1, parcels 3 are stored in the segments. In each segment, each time, three parcels are shown in superposed manner. Numbers 01, 02, 03, 04, . . . 09 are caused to appear on the parcels 3 that are distributed in the stowage zone in a certain distribution plan.

In this example, the parcels 3 are not ordered in the stowage zone.

In a travel path, this figure shows three shuttle robot carts 4 in a queue that are moved under the control of a monitoring and control unit 5 (a computer) for taking the parcels 3 from the stowage zone so as to cause them to exit from the travel path 2 in series via the inlet/outlet 6 and so as to bring them to a loading point at which they are loaded onto a truck (not shown).

The double-headed arrow 7 in the travel path indicates the two travel directions for the shuttle robot carts 4 along the travel path 2.

In FIG. 2, the ordered sequence of the parcels is illustrated with the parcel numbers, namely, in this example, 9, 8, 7, 6, 5, 4, 3, 2, 1. In this sequence, the parcel numbered 01 should exit first from the stowage zone 1, and the parcel numbered 09 should exit last from said stowage zone 1.

The parcel distribution plan indicating how the parcels are distributed in the stowage zone and the ordered sequence are both recorded in a memory in the unit 5, e.g. in a database.

In accordance with the invention, and in this example, the unit 5 causes the three shuttle robot carts 4 to move cyclically.

FIG. 3 shows various successive movement control cycles for causing the shuttle robot carts 4 to move.

At cycle C1, all of the parcels are present in the stowage zone and they distributed in the distribution plan shown in FIG. 1.

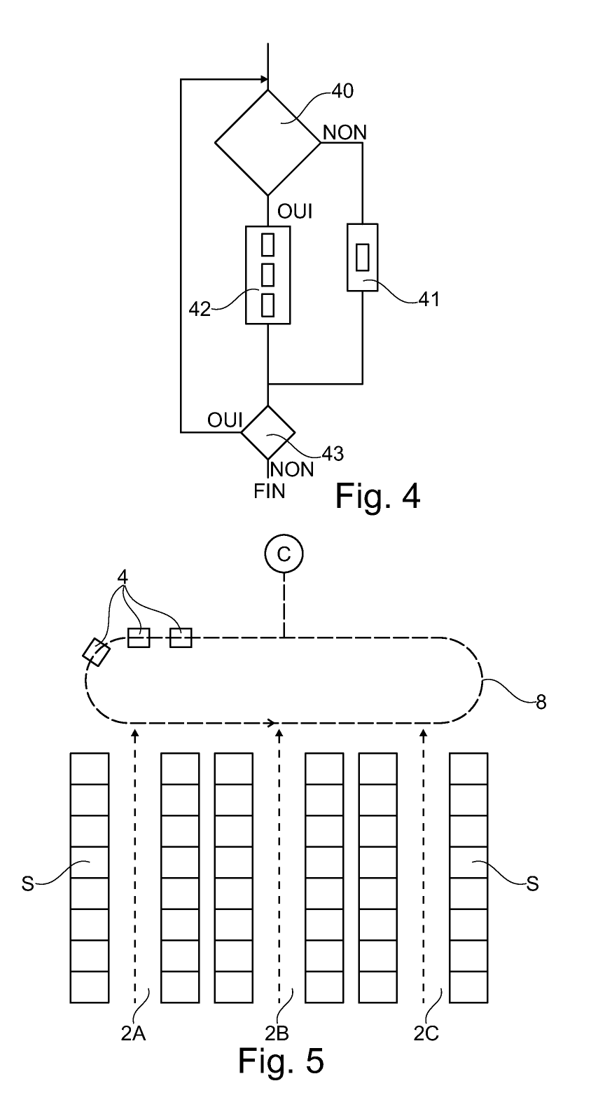

On the basis of this distribution plan and of the ordered sequence of the parcels, the unit 5 determines (step 40 in FIG. 4) whether a plurality of parcels 3 to be taken are stowed in sequence along the travel path 2 in the sequential order of FIG. 2.

For cycle C1, the unit detects that the parcels numbered 02 and 01 are stowed in the sequential order.

The unit 5 causes two shuttle robot carts 4 to move along the travel path to take these two parcels and to cause them to exit from the travel path in series. It can thus be understood that, in this situation, as many shuttle robot carts come into the travel path as there are parcels to be taken for the current control cycle.

At the following cycle C2, the unit 5 detects that a plurality of parcels are not stowed in the sequential order. It then (in step 41 of FIG. 4) causes a single shuttle robot cart 4 to be moved along the travel path to take the parcel numbered 03 only.

At the following cycle C3, the unit 5 detects that three parcels numbered 06, 05, 04 are stowed in the sequential order. It causes three shuttle robot carts 4 to move along the travel path (block 42 in FIG. 4) so as to take these three parcels and so as to cause them to exit from the travel path in series.

At the following cycle C4, the unit 5 detects that a plurality of parcels are not stowed in the sequential order. It then causes one shuttle robot cart 4 to be moved along the travel path to take the parcel numbered 07.

At the following cycle C5, the unit 5 detects that two parcels numbered 09 and 08 are stowed in the sequential order. The unit 5 causes two shuttle robot carts 4 to move along the travel path to take these two parcels and to cause them to exit from the travel path in series.

The process stops automatically if there are no more parcels to be taken (step 43 in FIG. 4).

This process operates in the same way with two rows of segments on either side of the travel path, and also with a plurality of rows of segments and with a plurality of travel paths.

FIG. 5 shows a stowage zone with three parallel travel paths 2A, 2B, 2C that are connected to a travel loop 8 for shuttle robot carts 4. The direction of travel around the loop 8 is indicated by an arrow on the loop 8.

Rows of segments S are disposed on either side of each travel path.

In this configuration of the stowage zone, shuttle robot carts 4 can travel empty in a queue around the travel loop 8 while they are waiting to be moved towards the travel paths under the control of the unit 5.

In addition, the unit 5 is suitable for causing shuttle robot carts 4 to stop on the travel loop 8 for the purpose of inserting a train of shuttle robot carts 4 exiting from a travel path in such a manner that shuttle robot carts loaded with parcels are inserted into the travel loop.

With reference to FIG. 5, the parcels of the sequence may be dispersed over a plurality of travel paths, e.g. over the three travel paths 2A, 2B, and 2C, and thus, at each cycle, and for each travel path, the unit 5 is arranged to detect whether one or more parcels are stowed in sequence in said travel path. In addition, the unit 5 is also arranged to determine the order in which the shuttle robot carts loaded with the parcels and that are exiting from the travel paths should be inserted into the travel loop 8.

The robot shuttle carts loaded with the parcels on the travel loop 8 exit from the travel loop 8 at a point leading to the loading point shown by C in FIG. 5.

With the method of the invention, it is possible to have a fleet of shuttle robot carts, the number of which is equal to the number of adjacent segments along a travel path.

Naturally, the present invention is in no way limited to the above description of one of its implementations, which can undergo modifications without going beyond the ambit of the invention.

For example, it is possible to have a processing cycle for the unit 5 that is time-based, e.g. constituted by a determined period of time that corresponds to the maximum rotation time taken for the shuttle robot carts to transfer the parcels from the travel paths to the loading point C.

But the processing cycle of the unit 5 of the invention may be of variable duration if it is related, for example, to detection of a certain occurrence, e.g. detection that there are no more shuttle robot carts in the travel paths.

1. A method of handling articles in a logistics center including an article stowage zone subdivided into adjacent stowage segments along a travel path for shuttle robot carts, in which method a monitoring and control unit organizes the movement of said shuttle robot carts along the travel path in such a manner as to take the articles from the segments and to cause them to exit from the travel path in series and in ordered manner in a certain sequence, said method being characterized in that the monitoring and control unit causes the shuttle robot carts to move cyclically (C1, C2, C3, C4, . . . ) along the travel path, and, in that, on the basis of a distribution plan indicating the distribution of the articles in the segments of the stowage zone, and on the basis of said ordered sequence, at each cycle, the monitoring and control unit checks whether or not a plurality of articles to be taken are stowed along the travel path in the sequential order, and, if so, causes to move along the travel path as many shuttle robot carts as there are articles to be taken in the sequential order, and, otherwise, causes a single shuttle robot cart to move along the travel path for the purpose of taking a single article.

2. A method according to claim 1, characterized in that the monitoring and control unit causes shuttle robot carts to move around a travel loop that is connected to a plurality of travel paths.

3. A method according to claim 1, characterized in that the articles are parcels to be loaded in sequence onto a truck.
